(19) United States
(12) Patent Application Publication
(10) Pub. No.: US 2020/0074667 A1
(43) Pub. Date: Mar. 5, 2020

(54) Clothing Size Determination Systems and Methods of Use

(71) Applicant: Seven Tablets, Inc., Addison, TX (US)

(72) Inventors: Kishore V. Khandavalli, Frisco, TX (US); Jerrold Shane Long, Dallas, TX (US); Surya Sekhar Chandra, Dallas, TX (US); Venkatesh Kalluru, Leesburg, VA (US)

(21) Appl. No.: 16/557,796

(22) Filed: Aug. 30, 2019

Related U.S. Application Data
(60) Provisional application No. 62/725,925, filed on Aug. 31, 2018.

(51) Int. Cl. G06T 7/62; A41H 1/02; G01B 11/02; G06Q 30/06

(52) U.S. Cl. CPC G06T 7/62; G06Q 30/0621; G01B 11/022; A41H 1/02

(57) ABSTRACT

A computer-implemented method and system involve using a mobile smart phone to capture an image of a person for whom sizing dimensions are desired. A known dimension of the person or a reference target is included in the image. The image is processed by one or more servers. A scaling ratio can be determined from the known dimension and a pixel map of the image in which the item with the known dimension is identified. That scaling ratio may be used to determine nominal dimensions of desired portions of the person based on their pixel dimensions. For the girth dimensions, a matrix of pixel measurements of certain body portions may be used with a regression-derived formula developed from empirical data to accurately estimate the girth dimension at the chest or waist or other locations. Other methods and systems are disclosed.

### CROSS-REFERENCE TO RELATED APPLICATION

This application claims the benefit of U.S. Provisional Application Ser. No. 62/725,925, filed by Kishore Khandavalli, et al., on Aug. 31, 2018, entitled “Clothing Size Determination Systems and Methods of Use,” which is incorporated herein by reference in its entirety for all purposes.

### TECHNICAL FIELD

Aspects of the present disclosure relate to digital devices and, in particular, to clothing size determination systems and methods.

### BACKGROUND

A uniform generally refers to a type of clothing to be worn by members of an organization while participating in that organization's activity. Modern uniforms are worn by armed forces and paramilitary organizations such as police, emergency services, security guards, in some workplaces, by sports teams, and in schools. Nevertheless, because the members of an organization may have differing body shapes and sizes, each uniform should be individually sized to fit each member. In many cases, providers of uniforms typically utilize a test set of clothing items including a number of clothing elements, each having a different size, so that each member of the organization can correctly determine their individual size. This information is conveyed back to the uniform provider so that a uniform having a proper fit may be created for each member of the organization.

Beyond uniforms, nearly everyone wants clothing that fits properly. Yet, there are no strict standards used by all providers and at times sizing varies from source to source. Because of this, if one orders online, the customer frequently orders more than one size and then returns one or more of the clothing items shipped—often at the expense of the provider.

### SUMMARY

According to one illustrative embodiment, a computer-implemented method to determine clothing dimensions of a person to be measured, the method for use with a mobile smart phone and at least one server, includes the steps of receiving an input of a known dimension of a feature of the person to be measured, wherein the input is made on the mobile smart phone and capturing at least one photograph of the person with the mobile smart phone, wherein the photograph includes the feature with the known dimension. The method further includes developing a pixel map of the photograph using a processor of the mobile smart phone or of the at least one server in communication with the mobile smart phone; identifying the feature having the known dimension and determining pixel dimensions of the feature using the pixel map, and developing a scaling ratio based on the pixel dimensions and the known dimension for the feature; and identifying an outline of the image of the person to be measured in the photograph or a portion thereof. The method further includes determining a pixel dimension of one or more portions of the person to be measured and using the scaling ratio to convert the pixel dimension of the one or more portions of the person to be measured to a sizing dimension.

According to one illustrative embodiment, a computer-implemented method to determine clothing dimensions of a person to be measured, the method for use with a mobile smart phone and at least one server, includes the steps of receiving an input of a known dimension of a feature on the person to be measured or on a reference target within 12 inches of the person to be measured. The input is made on the mobile smart phone. The method also includes capturing at least one photograph of the person with the mobile smart phone, wherein the photograph includes the feature with the known dimension; developing a pixel map of the photograph using a processor of the mobile smart phone or of the at least one server in communication with the mobile smart phone; and identifying the feature having the known dimension and determining pixel dimensions of the feature using the pixel map, and developing a scaling ratio based on the pixel dimensions and the known dimension for the feature. The method further includes identifying an outline of the image of the person to be measured in the photograph or a portion thereof; determining a pixel dimension of one or more portions of the person to be measured; and using the scaling ratio to convert the pixel dimension of the one or more portions of the person to be measured to a sizing dimension.

According to an illustrative embodiment, a clothing size determination system includes a clothing-sizing tool stored in a memory and executed by a processing system to: receive image data from a camera, the image data representing an image of a human subject and a feature of known dimension, the human subject and the feature of known dimension in a same field of view or proximate one another; process the feature of known dimension of the image data to develop a pixel-based measurement of the feature of known dimension; and produce a measurement ratio comparing the known dimension to the pixel-based measurement of the known feature. The clothing-sizing tool is further configured to process the photograph to identify one or more body features of the human subject for which sizing dimensions are desired; determine a measurement of the one or more body features in terms of pixels; and use the measurement ratio and the measurement of the one or more body features in terms of pixels to determine one or more nominal dimensions corresponding to the one or more body features of the human subject.

According to another illustrative embodiment, a customized clothing fitting system includes a clothing-sizing service stored in a memory and executed by a processing system to: receive one or more manufacturer's size charts associated with one or more clothing items provided to a retailer from a manufacturer, each of the manufacturer's size charts including a plurality of specified clothing sizes for each of the provided clothing items and a plurality of corresponding nominal dimensions; store the plurality of specified clothing sizes and corresponding nominal dimensions in a database; and receive a unique identifier of a consumer from a consumer computing device. The clothing-sizing service further configured to obtain one or more nominal dimensions associated with body features of the consumer; search through the database to identify one or more of the clothing items having one or more nominal dimensions that match one or more of the nominal dimensions of the consumer; and transmit information associated with the identified one or more clothing items to the consumer computing device. The one or more nominal dimensions is determined using a clothing size determination system.

The clothing size determination system of the previous paragraph includes a clothing-sizing tool stored in a memory and executed by a processing system to carry out a number of steps including receive image data from a camera, the image data representing an image of a human subject and a feature of known dimension, the human subject and the feature of known dimension in a same field of view or proximate one another, process the feature of known dimension of the image data to develop a pixel-based measurement of the feature of known dimension, and produce a measurement ratio comparing the known dimension to the pixel-based measurement of the known feature. The clothing-sizing tool further is configured to process the photograph to identify one or more body features of the human subject for which sizing dimensions are desired, determine a measurement of the one or more body features in terms of pixels, and use the measurement ratio and the measurement of the one or more body features in terms of pixels to determine one or more nominal dimensions corresponding to the one or more body features of the human subject.

### BRIEF DESCRIPTION OF THE DRAWINGS

The various features and advantages of the technology of the present disclosure will be apparent from the following description of particular embodiments of those technologies, as illustrated in the accompanying drawings. In the drawings, the like reference characters may refer to the same parts throughout the different views. The drawings depict only typical embodiments of the present disclosure and, therefore, are not to be considered limiting in scope. Additionally, the drawings are representative of one or more embodiments of the present disclosure and may not be drawn to any particular scale relative to one another.

FIG. 1 illustrates a representative environment, in side elevation, for operation of a clothing size determination system according to an illustrative embodiment of the present disclosure;

FIG. 2 illustrates an example front view photograph of a front image of the human subject that may be taken by a clothing size determination system according to one illustrative embodiment of the present disclosure;

FIG. 3 illustrates an example side view photograph of a side image of the human subject that may be taken by the clothing size determination system according to one illustrative embodiment of the present disclosure;

FIG. 4 illustrates a number of components of a clothing size determination system according to one illustrative embodiment of the present disclosure;

FIG. 5 illustrates an illustrative process that may be used by a mobile smart phone in conjunction with an online (Internet) server according to one illustrative embodiment of the present disclosure;

FIGS. 6A-6F illustrate several example user interfaces that may be generated on a mobile smart phone according to one illustrative embodiment of the present disclosure;

FIGS. 7A and 7B illustrate an example customized clothing fitting system and several components of a retailer server, respectively, according to one illustrative embodiment of the present disclosure;

FIG. 8 illustrates one example record that may be stored in a database according to one illustrative embodiment of the present disclosure;

FIG. 9 illustrates an example process 900 that may be performed by a clothes selection service according to one illustrative embodiment of the present disclosure;

FIG. 10 illustrates an example representative hardware environment for practicing a clothing size determination system according to one illustrative embodiment of the present disclosure;

FIG. 11 illustrates a representative environment from a side for operation of a clothing size determination system according to an illustrative embodiment of the present disclosure;

FIG. 12 illustrates representative hardware for one illustrative embodiment of the present disclosure;

FIG. 13 is an illustrative screenshot of a mobile smart phone representing the initial upfront pose scan;

FIG. 14 is an illustrative screenshot of a mobile smart phone showing adjustment sliders to be positioned by the user on the front pose at the shoulder, waist, and knee;

FIG. 15 is an illustrative screenshot of a mobile smart phone showing adjustment sliders to be positioned by the user on the front pose at the chest and hip;

FIG. 16 is an illustrative screenshot of a mobile smart phone showing adjustment sliders to be positioned by the user on the top of the torso and bottom of the torso and, also, the inseam;

FIG. 17 is an illustrative screenshot of a mobile smart phone showing adjustment sliders to be positioned by the user on the arm for sleeve-top alignment (top, mid, and bottom);

FIG. 18 is an illustrative screenshot of a mobile smart phone representing the a side scan of the person to be measured;

FIG. 19 is an illustrative screenshot of a mobile smart phone showing adjustment sliders on the side pose to be positioned by the user on the chest, waist, hip, and knee; and

FIG. 20 is an illustrative screenshot of a mobile smart phone showing adjustment sliders on the side pose to be positioned by the user where the top of a garment would go and the bottom of the garment would go.

### DETAILED DESCRIPTION

In the following detailed description of the preferred embodiments, reference is made to the accompanying drawings that form a part hereof, and in which is shown, by way of illustration, specific embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the claims.

Referring now to the drawings, and initially to FIG. 1, a representative environment for operation of a clothing size determination system 100 according to one illustrative embodiment of the present disclosure is presented. A human subject 102, for whom clothes dimensions are to be obtained, is positioned against, which includes immediately adjacent or within a few inches, to a wall 104 proximate to a two-dimensional reference target 106 mounted on the wall 104. The human subject 102 is shown with shoes on, but typically this image would be taken with shoes off. The reference target 106 or features 107 on the reference target are of a known size or known dimension. As used herein, “wall” may be any visual plane that can hold the reference target 106 proximate to the human subject 102. Typically, the wall 104 is an ordinary wall in a room, but in other embodiments may be a portable backdrop or suspension elements.

A mobile smart phone 108, which is manipulated by a user 110 (e.g., photographer), is configured to display a real-time video image provided by a camera 112 configured in the mobile smart phone 108. As used herein “mobile smart phone” is meant to include any computing device that captures digital images and allow for processing including smart phones (iPhone, Android, Blackberry, Windows phone, Samsung Galaxy, etc.), computing tablets (e.g., iPad, Microsoft Surface, etc.), portable computers, laptop computers, desktop computers, workstations, wireless cameras communicating with a computing device or other suitable computing device that is configured with a camera or in communication with a camera external to its housing. The user 110 positions the mobile smart phone 108 such that an image of the human subject 102 and reference target 106 are displayed on a screen 114 of the mobile smart phone 108 or otherwise captured together.

In this illustrative embodiment, the user 110 holds the mobile smart phone level with the assistance of a rotation sensor component (e.g., gyroscope) configured in the mobile smart phone 108. Additionally, the user 110 may hold the mobile smart phone 108 at a desired distance from the human subject 102, or person to be measured, with the assistance of the mobile smart phone 108 as will be described in detail herein below. The “desired distance” is a distance that allows the human subject 102 and the reference target 106 to be captured in the same frame; in some illustrative embodiments the desired distance is between four to eight feet. Once level and at the desired distance, the mobile smart phone 108 takes a digital photograph or image, which may be referred to herein as a “photograph” herein. According to one illustrative embodiment of the present disclosure, the clothing size determination system 100 may be configured to determine one or more clothes dimensions for a corresponding one or more body features using a photograph of a front image of the human subject 102 with the reference target 106, and another photograph of a side image of the human subject 102 with the reference target 106. The system 100 may arrive at the specific dimensions or may determine discrete size for the human subject 102. As used herein, “or” does not require mutual exclusivity.

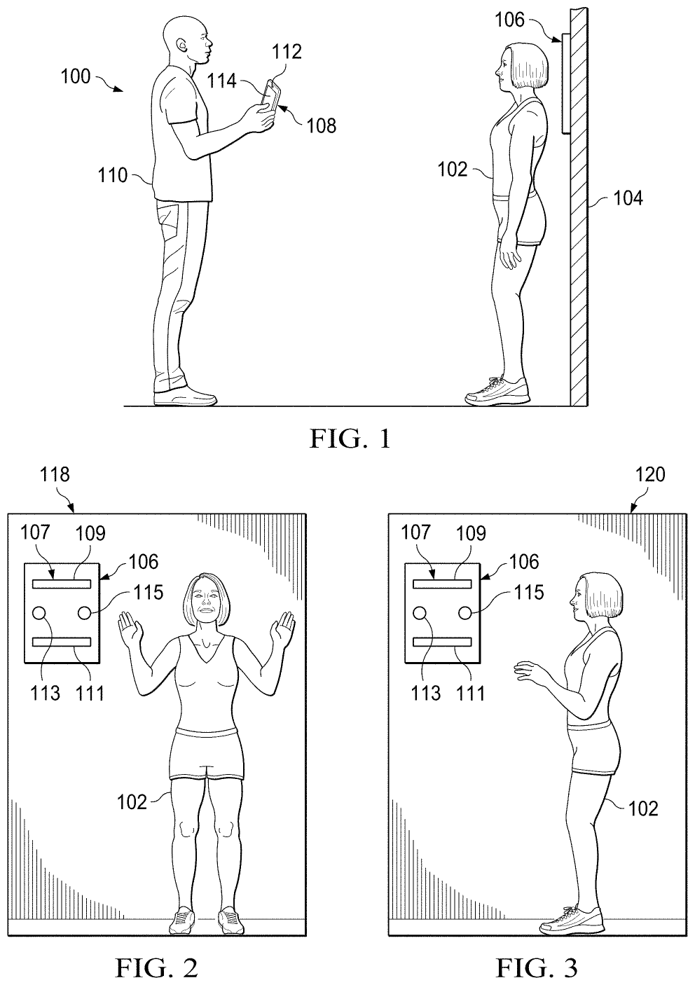

Referring now primarily to FIG. 2, an example front view photograph 118 of a front image of the human subject 102 that may be taken by the user 110 (FIG. 1) using the clothing size determination system 100 is presented. In particular, FIG. 2 shows the front view that the user 110 might see in FIG. 1 except that the human subject 102 has their arms positioned upwards as opposed to the human subject 102 having their arms down and hands at their hips as shown in FIG. 1. Various poses may be used. In this view, the reference target on the wall 104 is shown clearly. The two-dimensional reference target 106 is used to provide a scale for the pixel measurements used by the clothing size determination system 100.

In some embodiments, the two-dimension reference target 106 may have various patterns or features 107 that assist in providing a scale. In this embodiment, the reference target 106 includes features 107 in the form of two horizontal longitudinal bars 109 and 111 and two circles 113 and 115 separated by a distance. As noted further below, in some embodiments, a feature of the human subject, e.g., vertical height, is used as the target.

Referring now primarily to FIG. 3 another example side view photograph 120 of a side image of the human subject 102 that may be taken by the clothing size determination system 100 is presented. FIG. 3 is similar to FIG. 2 except that the side view photograph 120 shows a side image of the human subject 102 as opposed to a front image as shown in FIG. 2.

In general, the two-dimensional reference target 106 is positioned on a wall so that, when the photographs 118 and 120 are taken, an image of the reference target 106 is shown proximate the human subject 102 in the background of the photographs 118 and 120 in approximately (within a foot) the same plane as the subject. The reference target 106 has a fixed size, and may be printed by the user 110, or other person, using a standard quality printer on a sheet of paper, such as a 8.5×11 inch sheet of paper or other size paper. When processing the pictures, the mobile app detects the presence of the reference target 106 in the photographs, e.g., photographs 118 and 120, and uses the reference target 106 to compare against various dimensions of the human target 102 so that a relatively accurate determination of body size may be obtained. The two-dimensional feature of the reference target 106 enables the mobile app to correct for various aspect ratios (e.g., quantity of horizontal pixels vs. quantity of vertical pixels) that may be encountered through the use of different types of mobile smart phone camera components. Although a two-dimensional reference target 106 is shown and described herein, it is also contemplated that a one-dimensional reference target may be used if the two-dimensional reference target is not needed or desired. In some embodiments, one or more of the known feature dimensions of the reference target are used to gauge corresponding dimensions for each pixel measurement and then features of the photograph can be sized in terms of pixels and then given a physical dimension.

The clothing size determination system 100 may determine a clothes dimension for any suitable body feature of the human subject 102. Examples of body features for which clothes dimensions may be determined may include overall height, a waist size, a chest size, a body trunk length, a leg length, and a shoulder width. Clothing dimensions for other body features may be provided by the clothing size determination system 100 without departing from the spirit and scope of the present disclosure. While clothing dimensions are referenced, to be clear, the system 100 may determine the body dimensions at various locations and may then determine a suggested clothing size.

In some embodiments, the process is undertaken without the two-dimensional reference target 106. In order to calibrate the system 100, the person being measured enters his or her height information. The system 100 identifies the person in the captured image and matches the pixel height with the user-entered height in order to calibrate the system 100. The number of pixels in the image for the height is related to the user-entered height to develop the ratio used to go from pixel distances to actual distances that are used for sizing.

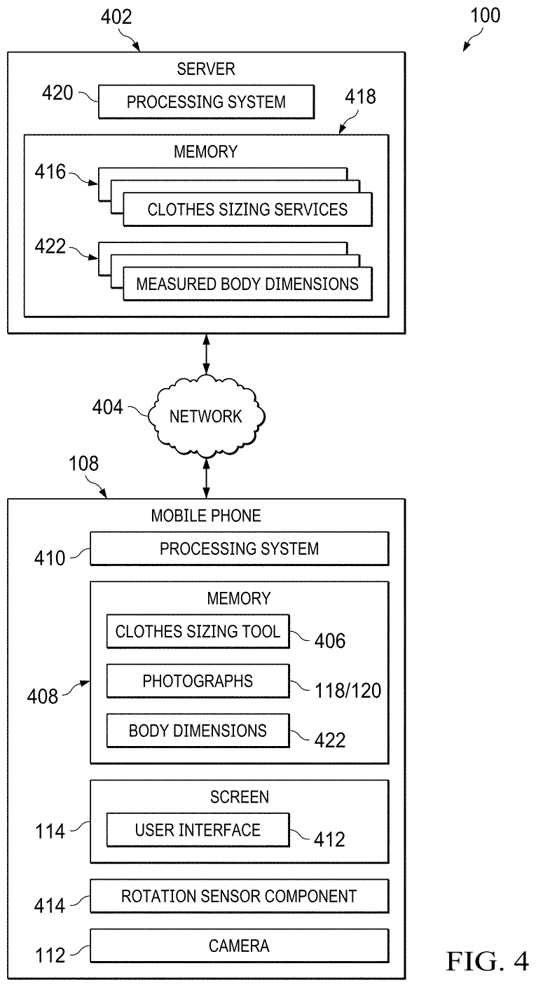

Referring now primarily to FIG. 4, several components or modules of a clothing size determination system 100 according to one illustrative embodiment of the present disclosure are illustrated. In the particular illustrative embodiment shown, the mobile smart phone 108 communicates with a server 402 through a communication network 404 (wired or wireless) to perform the various features of the clothing size determination system 100 described herein. That is, the mobile smart phone 108 may perform certain features of the present disclosure, while the server 402 may perform other certain features of the present disclosure. Such an arrangement may be useful for off-loading certain computationally intensive tasks (e.g., algorithms) that may unduly burden the operation of the mobile smart phone 108. Nevertheless, it is contemplated that in other embodiments, all tasks associated with operation of the clothing size determination system 100 may be performed by the mobile smart phone 108, or only minimal tasks associated with the operation of the clothing size determination system 100 are performed by the mobile smart phone 108.

The mobile smart phone 108 includes a clothing-sizing tool 406 or module that is stored in a memory 408 and executed on a processing system 410 of the mobile smart phone 108. The sizing tool 406 is shown as part of the mobile phone, but in other embodiments it is included as an aspect of the server 402. The processing system 410 includes one or more processors. The mobile smart phone 108 may include any type of computing system, such as one or more management computing systems, personal computers, mobile computers or other mobile devices, or other hosts. The clothing-sizing tool 406 may include instructions that may be executed in a suitable operating system environment, such as an Apple™ iOS operating system, or an Android operating system environment, or other operating system as one skilled in the art would understand. In other embodiments, the clothing-sizing tool 406 may be executed in a Windows, a Linux, or a UNIX operating system environment if implemented in a laptop, desktop, or workstation computing environment. Although the clothing-sizing tool 406 is shown and described as a computer-based design incorporating instructions stored in a memory 408 and executed by a processing system 410, it should be understood that the clothing-sizing tool 406 may be embodied in other specific forms, such as using discrete or integrated analog circuitry, field programmable gate arrays (FPGAs), application specific integrated circuitry (ASICs), or any combination thereof.

The mobile smart phone 108 includes a rotation sensor component 414 (e.g., gyroscope) that may be used to assist the user in orienting the mobile smart phone 108, and a camera 112 that is used to take photographs 118, 120 of the human subject 102. According to one aspect, the mobile smart phone 108 also provides a user interface 412, which may be displayed on a display 114 (FIG. 1) such as a screen of the mobile smart phone 108. The screen of the mobile smart phone 108 may function as an input device for entry of user input or to otherwise interact with the user.

The memory 408 comprises a non-transitory computer readable medium. In one illustrative embodiment, the memory 408 comprises one or more of the following: volatile media, nonvolatile media, removable media, non-removable media, or another available medium. In some illustrative embodiments, the memory 408 may include computer storage media, such as non-transient storage memory, volatile media, nonvolatile media, removable media, or non-removable media implemented in a method or technology for storage of information, such as computer readable instructions, data structures, program modules, or other data. The memory 408 may also store data used for operation of the clothing-sizing tool 406. For example, the memory 408 may store one or more photographs 118, 120, or one or more body size dimensions as determined by the clothing-sizing tool 406, or may store a knowledge-based look up table.

The mobile smart phone 108 communicates with the server 402 through a suitable communication network 404, such as a public switched telephone network (PSTN), or plain old telephone service (POTS), or a cellular network, such as a global system for mobile communications (GSM) network, or a code division multiplex access (CDMA) network. Additionally, the mobile smart phone 108 may communicate with the server 402 through a wide area network (WAN), such as the Internet or other means.

The server 402 may include one or more clothes sizing services 416 that may perform one or more features of the clothing size determination system 100. The clothes sizing services 416 are stored in a memory 418 and executed on a processing system 420 of the server 402. The memory 418 and processing system 420 may have certain features similar to the memory 408 and processing system 410 of the mobile smart phone 108 as described above.

The clothes sizing services 416 may perform any suitable task in support of the clothing size determination system 100. For example, one clothing sizing service 416 may include an algorithm for obtaining actual (e.g., empirically measured) body dimensions for each of the multiple human test subjects and correlating the body dimensions obtained through the use of the mobile app process. That is, a number of human test subjects (e.g., 100 people) may have their body dimensions manually measured, and undergo the mobile app process of having front and side pictures taken and processed. The actual body dimensions may then be correlated with the body dimensions obtained via the mobile app process to calibrate the measurement algorithm. The test subjects may be grouped according to certain classes of possible body shapes, heights, gender, age, and the like. Thus, when the mobile app is executed, it may receive such information from the user to enhance the accuracy of the clothes-sizing algorithm. The algorithm is a knowledge base to further improve accuracy.

As another example, another clothes sizing service 416 may include one that removes extraneous background imagery from the photographs 118, 120. Such a feature may be useful for further processing to enhance the determination of certain body features (e.g., a waistline, a chest width, a shoulder width, a leg length, etc.) in which the background imagery may obfuscate how those body features are determined. In some embodiments, the background imagery removal service may include a tensor algorithm that processes raw photographs obtained from the camera of the mobile smart phone to remove all background imagery. Thus, the resulting process pictures may include only outline information of the human subject from which body dimensions may be obtained. In some embodiments, the wall may be a green screen to make this portion easier.

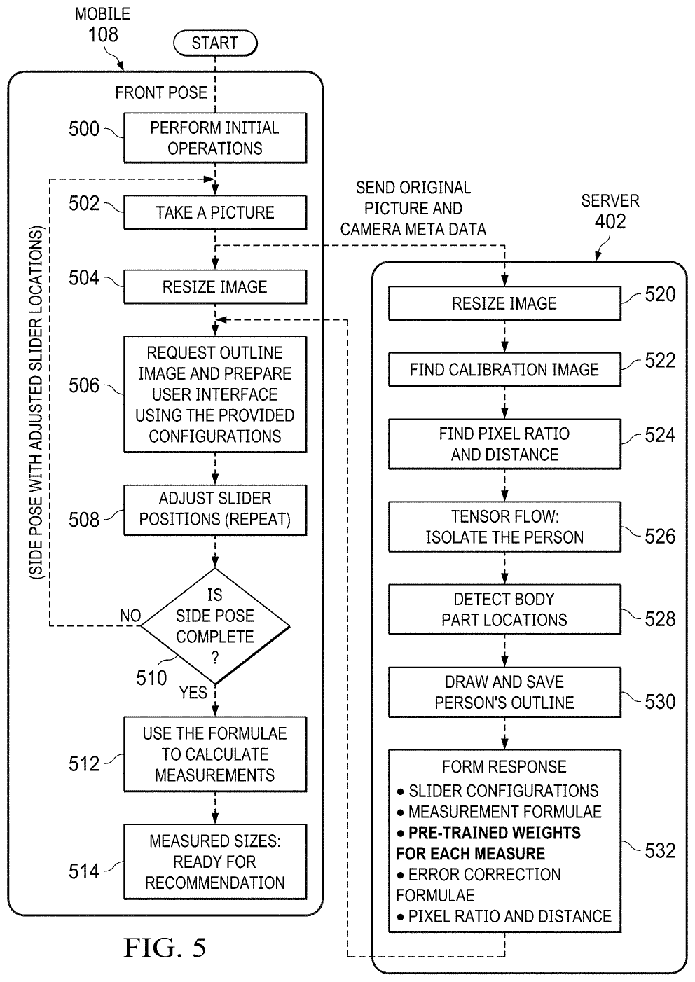

Referring now primarily to FIG. 5, an illustrative process that may be used by the mobile app of a mobile smart phone in conjunction with an online (Internet) server 402 is presented. In general, steps 500 through 514 describe actions taken by the mobile app, while steps 520 through 532 describe actions taken by the server 402. Those skilled in the art will understand that variations in the steps and where they are performed may be made.

At step 500, the clothing-sizing tool 406 performs one or more initial operations. When the clothing-sizing tool 406 is initially launched or otherwise started, it may, among other things, display, on the user interface 412, information about how to print the reference target 106 by the user 110. The information may include instructions on how to establish a communication channel with a printer. When the channel with the printer is established, the clothing-sizing tool 406 may automatically print the reference target 106, or wait for user input to print the target 106. The information may also include an interactive request to receive information about the human subject 102, such as gender, age, ethnicity, etc. so that the clothing-sizing tool 406 can use classification information (knowledge base) obtained about varying types of body shapes during its calibration for enhancing the accuracy of the clothing-sizing tool 406.

At step 502, the user (e.g., photographer) takes a photograph 118 or 120 of the human subject 102 (e.g., person to be measured), which is thereafter transmitted to the server 402. The picture may be transmitted with meta data associated with the photograph.

At step 520, the server 402 may resize the photograph/picture 118 or 120 (e.g., image) as desired for processing. For example, the server 402 may resize the photograph 118 or 120 such that an image of the human subject 102 extends over a largest extent of the photograph without any cropping of the human subject's image. The subroutine of the server 402 may identify the primary image on the wall in the photograph other than the target. The server 402 may then expand the captured image of the photograph an incremental amount and then ask if the outline of the image has exceeded a boundary. If not, the server may again incrementally expand the image and ask the same question. This loop would continue until the image is at the boundary and the condition becomes false.

At step 522, the server 402 identifies the reference target image (e.g., calibration image) of the reference target 106 in the photograph. At step 524, the server 402 determines a distance and relative pixel ratio using the reference target image. At step 526, the server 402 removes background imagery. At step 528, the server 402 detects certain key body part locations, such as chest, waist, hip, leg length, and the like. This may involve looking for the narrowest shape along a vertical to identify the waist and like algorithms for other body parts. At step 530, the server 402 constructs and saves the human subject's outline in its memory.

At step 532, the server 402 prepares information for a user interface 412 to be displayed on the mobile smart phone 108, and transmits the user interface information to the mobile smart phone 108. In one illustrative embodiment, the information may include one or more slider configurations to be used by the user for manually manipulating or identifying certain body part locations. For example, the server 402 may make an initial determination about the relative location of certain body parts, e.g., the person's waist, and provide one or more manually manipulatable sliders to allow the user 110 to finely tune a precise location of those body parts on the user interface 412 of the mobile smart phone 108. In another embodiment, the server 402 may provide certain formulae (e.g., measurement formulae, error correction formulae, etc.) to be used by the clothing-sizing tool 406 for calculating one or more clothes sizes according to a measured size of the human subject image. In yet another embodiment, the server 402 may provide pre-trained weights to be used for each measurement according to the calibration procedure described above. That is, the server 402 may determine certain weights to be used for each body part location according to classification information known about the human subject 102, such as gender, age, ethnicity, and the like. The server 402 may also provide measured values of pixel ratio (e.g., density of horizontally oriented pixels vs. density of vertically oriented pixels) and relative distance values obtained using the image of the reference target 106.

At step 504, the mobile smart phone 108 may resize the photograph 118, 120 as needed. Resizing of the image is done with tools available with the browser. In some embodiments, step 504 is omitted.

Thereafter at step 506, the mobile smart phone 108 displays the processed image of the human subject 102 on the user interface 412 along with other information provided by the server 402.

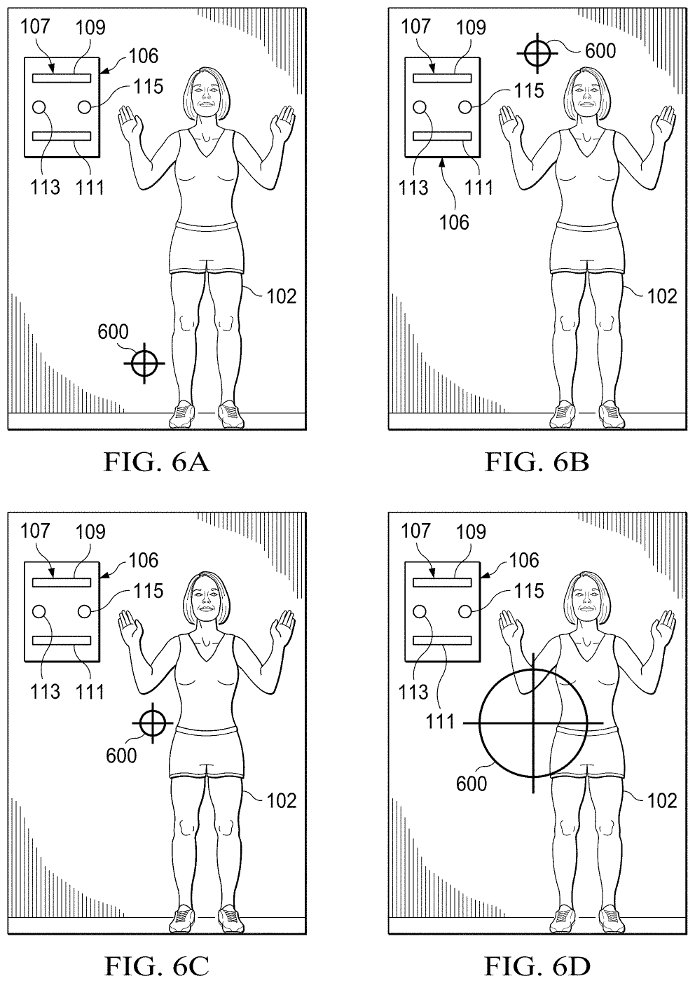

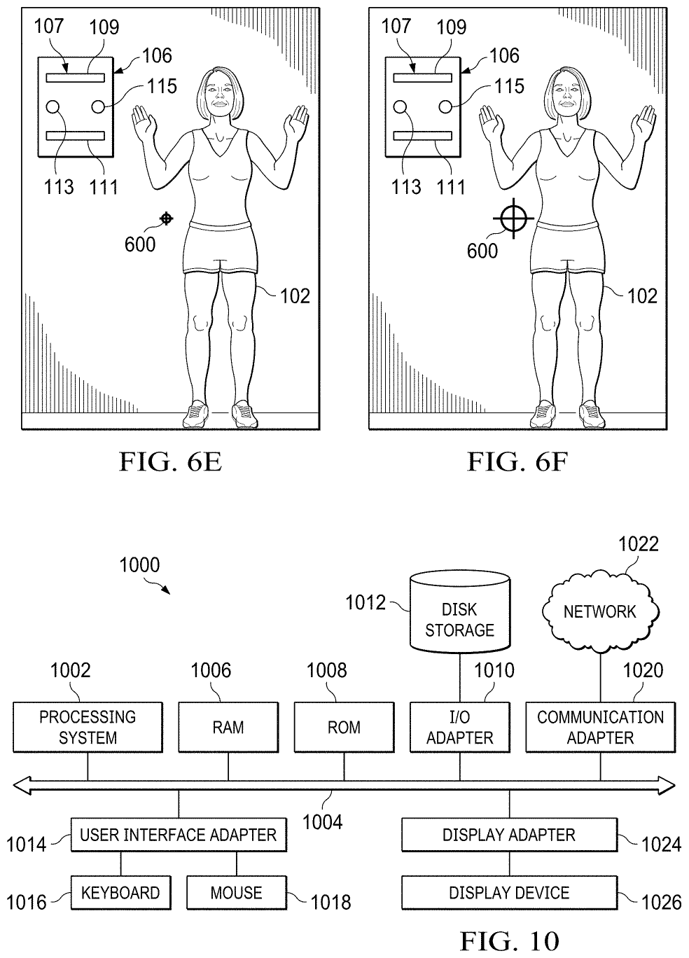

In one illustrative embodiment, the mobile smart phone 108 may display a visual indicator 600 (See FIGS. 6A, 6B, and 6C) on the user interface 412 for assisting the user 110 with proper orientation of the camera 112 and distance of the camera 112 from the human subject 102. For example, the clothing-sizing tool 406 may display the visual indicator 600 so that it proportionally moves up and down as the camera 112 is tilted using a rotation sensor component 414 (gyroscope) configured in the mobile smart phone 108. For example, FIG. 6A illustrates a relative position of the visual indicator 600 showing that the camera 112 is tilted too low since the visual indicator 600 is at the bottom. FIG. 6B illustrates a relative position of the visual indicator 600 showing that the camera 112 is tilted too high since it is at the top. FIG. 6C illustrates a relative position of the visual indicator 600 showing that the camera 112 is tilted at a proper angle for taking the photograph 118 or 120 because the visual indicator is substantially centered. In some embodiments, this visual indicator 600 may be a floating star that, when aligned to an on-screen target box, triggers an image capture.

In another embodiment, the mobile smart phone 108 may display the visual indicator 600 so that it proportionally increases or decreases in size according to a zoom level of the camera 112. For example, FIG. 6D illustrates a relative size of the visual indicator 600 showing that the zoom level of the camera 112 is too large since it is larger than half the target. FIG. 6E illustrates a relative size of the visual indicator 600 showing that the zoom level of the camera 112 is too small. FIG. 6F illustrates a relative size of the visual indicator 600 showing that the camera 112 has an appropriate zoom level for taking the photograph 118 or 120.

In some embodiments, the clothing-sizing tool 406 may change a color of the visual indicator 600 when an appropriate zoom level is reached. For example, the clothing-sizing tool 406 may display the visual indicator 600 in a first color (e.g., red) when the zoom level is not appropriate, and change the visual indicator to a second color (e.g., green) when the zoom level of the camera 112 is appropriate. The clothing-sizing tool 406 may obtain the zoom level of the camera 112 by accessing an application program interface (API) of the camera 112 through the mobile smart phone 108.

At step 508, the mobile smart phone 108 displays the processed image from the server 402 along with manually adjustable cursors or sliders that allow the user to provide fine adjustment of certain body features. For example, the mobile smart phone may display a determined location of the human subject's waist (narrowest portion), while providing a manually adjustable cursor to allow the user to finely adjust (fine tune) the determined location.

At step 510, if not already done, the mobile smart phone allows the user to take a side photograph 120 of the side of the human subject 102. Once front and side photographs have been taken, processing continues at step 512. The mobile smart phone 108 then calculates appropriate size information for the human subject at step 512.

At step 514, the mobile smart phone outputs the determined, appropriate size information for use by the user 110 or human subject 102. For example, the clothing-sizing tool 406 may store the determined clothes size information 422 in the memory 408 or may store it as body size. The body size may be used to determine clothing sizes for different clothing-size regiments or systems.

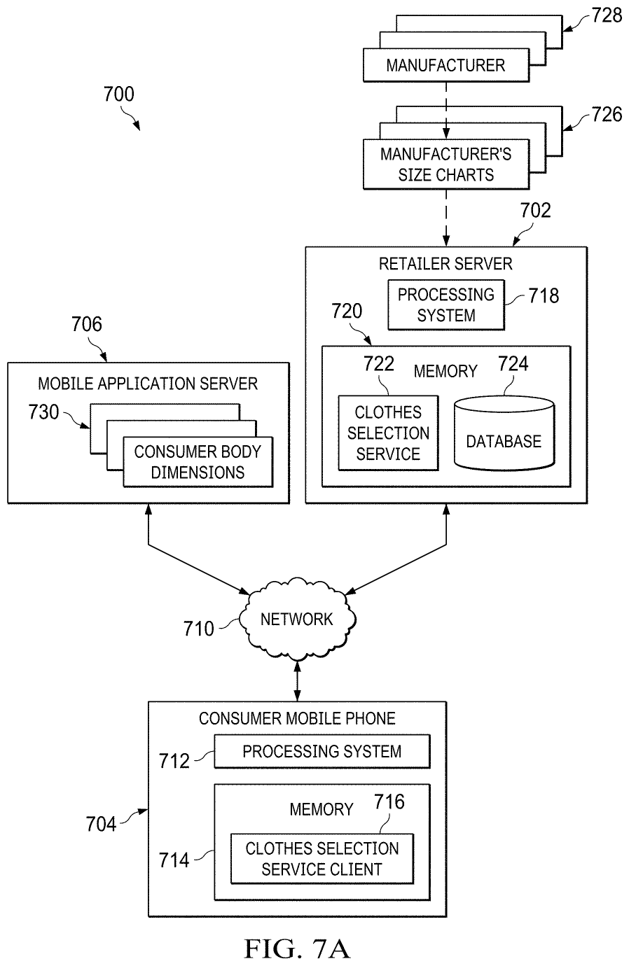

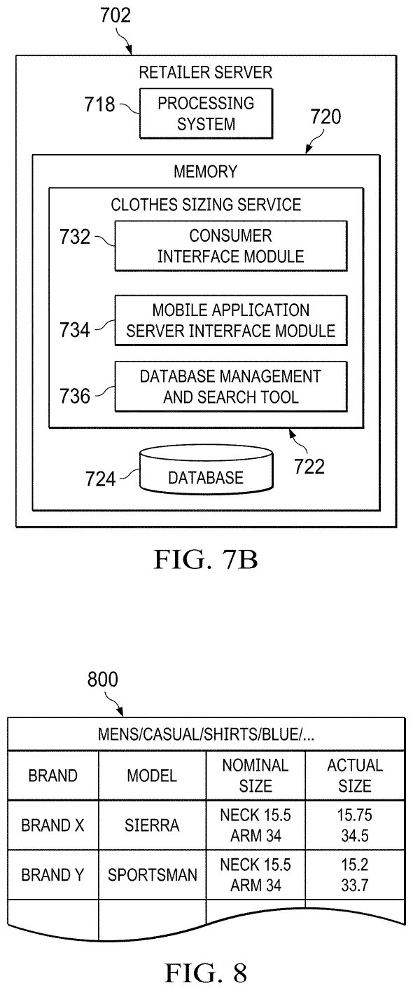

Referring now primarily to FIG. 7A, an illustrative customized clothing fitting system 700 according to one illustrative embodiment of the present disclosure is presented. The clothing fitting system 700 generally includes a retailer server 702 in communication with a consumer mobile smart phone 704, and a mobile application (app) server 706 through a communication network 710, such as the Internet. The consumer mobile smart phone 704, mobile app server 706, and communication network 710 may be similar in design and construction to the mobile smart phone 108, server 402, and communication network 404, respectively, as described above with reference to FIGS. 1-5. The consumer mobile smart phone 704 differs, however, in that it includes a processing system 712 and a memory 714 for storing a clothes selection service client 716.

The consumer mobile smart phone 704 is owned by a consumer, and the mobile app server 706 is managed by a mobile app provider, such as one that may provide the clothes selection service client 716 as a mobile app to be installed on the consumer mobile smart phone 704. The retailer server 702 is managed by a retailer of clothing items, and includes a processing system 718 and a memory 720 for storing a clothing-sizing service 722 or tool, and a database 724.

As described further below, the clothes selection service 722 receives multiple manufacturer's size charts (MSCs) 726 associated with one or more clothing items provided to the retailer from a clothing manufacturer 728 in which each of the manufacturer's size charts 726 includes multiple specified clothing sizes for each of the provided clothing items. The clothes selection service 722 stores the specified clothing sizes in a database 724 such that, when the clothes selection service 722 receives a unique identify of a consumer from a consumer computing device, it obtains one or more measured body dimensions associated with the consumer, and then searches through the database 724 to identify one or more of the clothing items having the specified clothing sizes that match the one or more measured body dimensions of the consumer. The clothes selection service 722 then transmits information associated with the identified one or more clothing items to the consumer mobile smart phone 704. In this way, the consumer can shop knowing the exact size that fits them best.

According to some illustrative embodiments of the present disclosure, the clothes selection service 722 obtains the measured body dimensions from the mobile app server 706. For example, the mobile app server 706 may initially determine the consumer body dimensions 730 of the consumer as referenced in FIGS. 1-6, so that, when a request for the consumer body dimensions 730 from the clothes selection service 722 is received, it may transmit the determined consumer body dimensions 730 to the clothes selection service 722. The consumer body dimensions 730 may be similar to the measured body dimensions 422 as described above with reference to FIG. 4. In another embodiment, when no measured body dimensions associated with the consumer are available from the mobile app server 706, the clothes selection service 722 may communicate with the consumer mobile smart phone 704 to establish a session with the mobile app server 706 for generating the consumer body dimensions 730.

The manufacturer's size charts 726 generally include information associated with actual dimensions of clothing provided by its respective manufacturer 728. In some cases, the manufacturer's size charts 726 may conform to one or more clothing size specifications, such as an International Organization for Standardization (ISO) 8559 specification, or an European Norms (EN) 13402 specification. Each manufacturer's size chart 726 may include information that correlates a nominal, or stated, clothing size of a particular clothing item with an actual clothing size. For example, whereas a particular clothing item may have a nominal waist size of 32.0 inches, its actual waist dimension may be 31.5 inches. The clothes selection service 722 may use this information to aid the consumer in selecting that particular size of clothing item that most closely matches the consumer's measured body size. The clothes selection service 722 may provide the best-fit size to the consumer or may provide a chart showing the correlation for the consumers own decision.

Referring now primarily to FIG. 7B, several components of the example retailer server 702 of FIG. 7A, according to one illustrative embodiment of the present disclosure, are presented in more detail. In particular, the retailer server 702 may include a consumer interface module 732, a mobile app server interface module 734, and a manufacturer's size chart database management and search module 736. The processing system 718 and memory 720 of the retailer server 702 may be similar in design and construction to the processing system 420 and memory 418 of the server 402 as described above with reference to FIG. 4.

The retailer server 702 may include a consumer interface module 732 for interacting with the consumer mobile smart phone 704 of the customer. For example, the consumer interface module 732 may include a website portal that can be accessed by the consumer mobile smart phone 704 to receive information from the consumer, such as a request to search for various clothing items provided by the retailer, or respond to such requests by providing information to the consumer information, such as providing the consumer with one or more clothing items matching that request. The retailer server 702 may also include a mobile app server interface module 734 to communicate with the mobile app server 706 for obtaining measured body dimensions 422 associated with the consumer. For example, the measured body dimensions 422 may be those as obtained above using the clothing size determination system 100 as described herein above.

The retailer server 702 may also include a manufacturer's size chart database management and search tool module 736 for managing the database, and searching through the database 724 for obtaining information about certain clothing items at the request of the consumer. Examples of database management may include, for example, receiving, parsing, and storing records of clothing items included in the manufacturer's size chart 726, modifications to existing records in the database 724, or deletion of discontinued records representing clothing items no longer sold by the retailer. An example of obtaining information about certain clothing items may include, for example, receiving request from the consumer mobile smart phone 704 for acquiring information about types of clothing items matching the body dimensions of the consumer, and responding to those requests with information about certain clothing items matching those requests.

Referring now primarily to FIG. 8, one example record 800 that may be stored in the database 724 according to one illustrative embodiment of the present disclosure is presented. In particular the example record 800 may be one of multiple records 800 stored in the database 724 and managed by the manufacturer's size chart database management and search tool module 736. In some embodiments, the record 800 might also just give a size “S,” “M,” “L,” or “XL” without giving actual measurements or numerical sizes. In one illustrative embodiment, the manufacturer's size chart database management and search tool module 736 may receive a request for a particular type of clothing item from the consumer mobile smart phone 704, filter through multiple different types of clothing items according to one or more criteria specified in the request, and transmit the information associated with the identified one or more filtered clothing items to the consumer mobile smart phone 704. In the particular record shown, the request includes filtering criteria including a men's clothing item, a casual dress type, a shirt clothing item, and a blue color. Although only a few criteria are described herein, it is contemplated that other clothing criteria may be used for searching without deviating from the spirit and scope of the present disclosure.

Within these criteria, the record 800 stores information about certain clothing items that may match the search criteria. For example, the record 800 may include a first column including information about a certain brand (e.g., make) of the clothing item, a second column including information about a specific model of the clothing item, a third column including information about a nominal, or stated, size of the clothing item, and a fourth column including information about an actual size associated with the nominal dimension. Although only a discrete number of dimensions are shown, it should be appreciated that the record 800 may store any quantity and type of clothes dimensions. For example, other example records 800 may store information about chest circumference, torso length, waist circumference, and the like.

When the manufacturer's size chart database management and search tool module 736 receives a request, it may obtain body dimensions 730 stored in the mobile app server 706, and select one or more of the clothing items that match the body size of the consumer. In one illustrative embodiment, the manufacturer's size chart database management and search tool module 736 may provide for selection of certain clothing items according to a desired fit style (e.g., loose fit, regular fit, tight fit, athletic fit, etc.). For example, the manufacturer's size chart database management and search tool module 736 may receive a request for a particular fit style from among a plurality of different types of clothing items from the consumer computing device, apply a weighting factor to the one or more measured body dimensions associated with the consumer, and search through the database to identify one or more of the clothing items having the one or more clothing sizes that match the one or more weighted measured body dimensions of the consumer.

In one illustrative embodiment, margin may be added to the dimensions during the search process; for example, if a loose fit is desired, 5% may be added to the consumer's torso dimension before searching the actual size column for matches. Information associated with those clothing items providing the desired fit style may then be transmitted to the consumer mobile smart phone 704 for consumption by the consumer. In other embodiments, a retailer may have an exclusive system so that only that retailer's goods are shown.

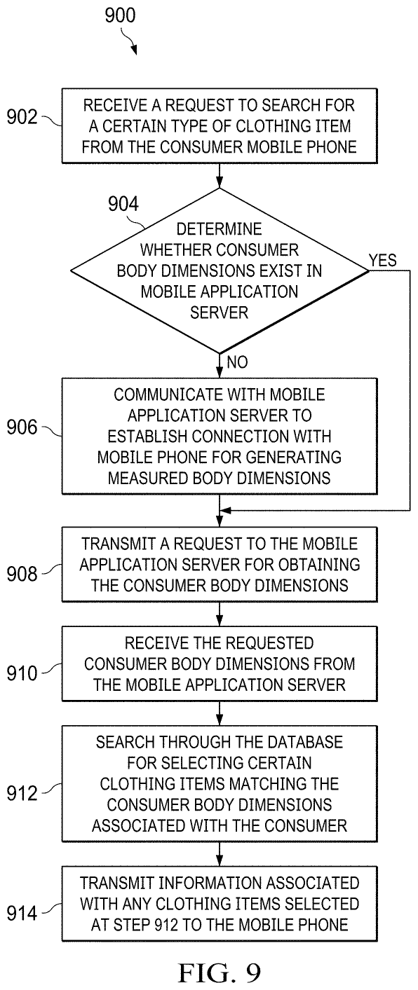

Referring now primarily to FIG. 9, an illustrative process 900 that may be performed by the clothes selection service 722 according to one illustrative embodiment of the present disclosure is presented. Initially, consumer body dimensions 730 may be obtained for a particular consumer (e.g., human subject 102) as described above with reference to FIGS. 1-5, and stored in the mobile app server 706.

At step 902, the clothes selection service 722 receives a request from the consumer mobile smart phone 704 to search for a certain type of clothing item. The request may include information associated with a unique identity of the consumer, such as a name, phone number, ID or social security number, and the like. The request may also include criteria such as type (e.g., gender type, color type, dress/casual type, etc.), as well as a fit type (e.g., loose fit, regular fit, tight fit, athletic fit, etc.) or a particular retailer.

At step 904, the clothes selection service 722 determines whether consumer body dimensions 730 exist in the mobile app server 706. If not, the process goes to step 906 and the clothes selection service 722 communicates with the mobile app server 706 to establish a connection with the consumer mobile smart phone 704 for generating measured body dimensions 730, such as may be performed above using the clothing size determination system 100. When the measured body dimensions 730 are generated, processing continues at step 908. If the answer to the determination is positive at interrogatory 904, the process proceeds directly to step 908.

At step 908, the clothes selection service 722 transmits a request to the mobile app server 706 for obtaining the consumer body dimensions 730. The request may include the unique identity of the consumer, such as may be received at step 902. Thereafter at step 910, the clothes selection service 722 receives the requested consumer body dimensions 730 from the mobile app server 706.

At step 912, the clothes selection service 722 searches through the database 724 to select certain clothing items matching the consumer body dimensions 730 associated with the consumer or may just provide sizing for a particular retailer for in store shopping or online shopping. In one illustrative embodiment, the clothes selection service 722 may include an algorithm for selecting only those clothing items that match the consumer body dimensions to certain degree. For example, when the consumer body dimensions 730 indicate that a waist dimension of consumer should have an actual clothing size of 32 inches, it may only select clothing items having an actual clothes dimension within a certain range below and above that dimension (e.g., 31 to 33 inches).

The clothes selection service 722 may also search according to criteria or fit type as provided by the consumer at step 902. For example, if the consumer was seeking a “casual fit” for jeans, the clothes selection service may only return clothing items with greater than average circumference but with the waist in the proper range.

At step 914, the clothes selection service 722 transmits information associated with any clothing items selected at step 912 to the consumer mobile smart phone 704. The information may then be displayed on the user interface of the mobile smart phone 704 for consumption by the consumer. For in-store shopping, the information may include where to find the selected clothing in the store, e.g. Men's store, Bay A.

The steps described above may be repeated for searching for other clothing items sold by the retailer of the retailer server 702. Nevertheless, when use of the clothes selection service 722 is no longer needed or desired, the process ends.

The description above includes example systems, methods, techniques, instruction sequences, or computer program products that embody techniques of the present disclosure. However, it is understood that the described disclosure may be practiced without these specific details.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., hard disk drive), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions. One illustrative example of suitable hardware follows.

Referring now primarily to FIG. 10, an example representative hardware environment 1000 for practicing one illustrative embodiment of the present disclosure is presented. In particular, the representative hardware environment 1000 may include certain components similar to the mobile device 108 or server 402, and execute one or more embodiments of the clothing size determination system 100 or customized clothing fitting system 700 as described above. The representative hardware environment 1000 includes a processing system 1002, which may include one or more microprocessors, and a number of other units interconnected via a system bus 1004. The processing system 1002 may include other circuitry not shown herein, which may include other types of circuitry typically found in a microprocessor, such as an execution unit, bus interface unit, Arithmetic Logic Unit (“ALU”), and the like. In some cases, the processing system 1002 may be embodied in a single Integrated Circuit (“IC”) chip.

The representative hardware environment 1000 includes a Random Access Memory (“RAM”) 1006 and a Read Only Memory (“ROM”) 1008. Also included are an I/O adapter 1010 for connecting peripheral devices such as disk storage units 1012 to the bus 1004, a user interface adapter 1014 for connecting a keyboard 1016, a mouse 1018 or other user interface devices, such as a touch screen device (not explicitly shown) to the bus 1004. The I/O adapter 1010 may be of any of several well-known types, including a serial interface, a parallel interface, a Universal Serial Bus (“USB”) and the like.

Further included in the representative hardware environment 1000 may be a communication adapter 1020 for connecting the representative hardware environment 1000 to a communication network 1022, such as the Internet. For user interface purposes, the representative hardware environment 1000 may include a display adapter 1024 for connecting the system bus 1004 to a display device 1026. In an alternative embodiment, the representative hardware environment 1000 may include additional display adapters (not shown) for connecting additional display devices (not shown) to the representative hardware environment 1000.

It will be appreciated that, although many processing systems 1002 may have many or all of these elements, each and every element described above is not required in order for a device to qualify as a representative hardware environment. One such device may be, for example, a Real Time Unit (“RTU”). A RTU generally includes a representative hardware environment 1000 adapted to receiving sensor or other real-time, or other non-real-time data. Accordingly, the I/O adapter 1010 is adapted to receive input from such sensors. However, the RTU may not have a user interface adapter 1014 or any of the elements attached thereto. In some alternative embodiments, the RTU may have a user interface adapter 1014, but the associated devices (keyboard 1016, mouse 1018, etc.) are only connected on a temporary basis, for installation, maintenance and the like. Similarly, the RTU may or may not have a disk storage unit 1012, or the like.

In one illustrative embodiment, the system is used to estimate Body Mass Index and body fat percentage. Body fat percentage is measured in several different ways: by fully immersing the body in water and measuring the displaced water and change in weight, body scanning, calipers measurement etc. While these measurements use different ways to compute the body fat, the results also vary. According to one illustrative embodiment, by measuring chest, waist, upper arms, thighs and hips, the Body Mass Index or percentage body fat may be accurately estimated. With the user input of height, weight, gender or demographic information, the system computes body fat percentage by comparing the measurements to a database of already existing user information. The body dimensions may be determine using the method and systems described above.

In one illustrative embodiment, a clothing size determination system includes an executable clothing-sizing tool that receives image data from a camera representing an image of a human subject and a two-dimensional reference target. The human subject and the two-dimensional reference target are positioned proximate one another within the image. The system processes a two-dimensional reference target portion of the image data to measure a relative distance of the camera from the human subject in which the relative distance is measured according to a size of the two-dimensional reference target portion relative to the overall size of the image. Using the measured relative distance, the system displays a visual indicator for indicating to a user of the camera, a desired distance of the camera from the human subject or an optimum orientation of the camera relative to the human subject. The system also receives and processes a photograph of the image to determine one or more body features of the human subject. Using the determined one or more body features, the system processes the photograph to determine one or more clothes dimensions corresponding to one or more body features of the human subject by comparing a relative size of each of the body features against the size of the two-dimensional reference target. Additionally, the system may adjust the determined clothes dimensions according to an empirical training model in which the determined one or more clothes dimensions are compared against the one or more body dimensions of a plurality of other human test subjects having known clothes dimensions. Other disclosures are presented.

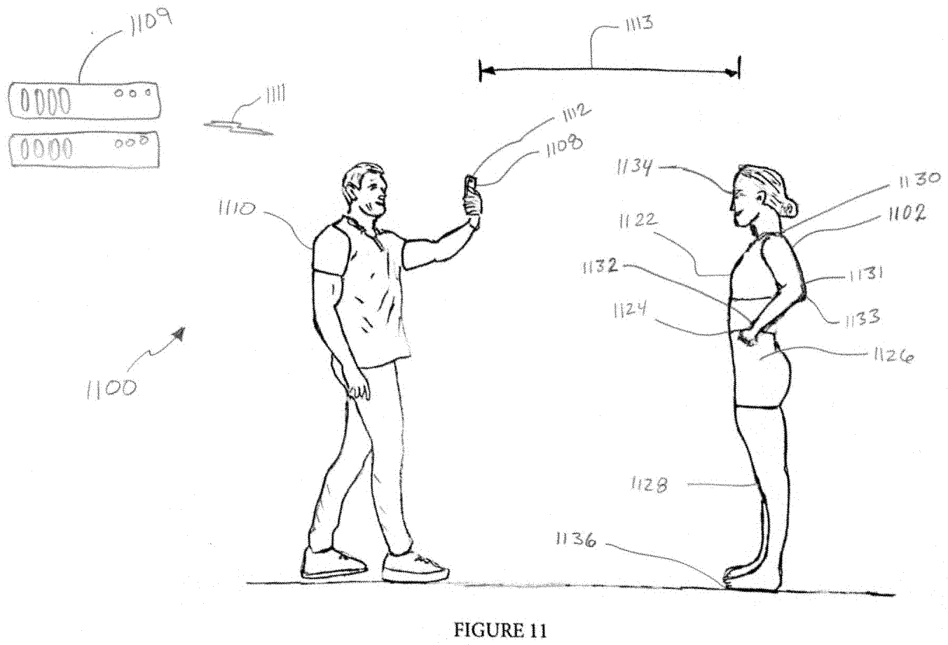

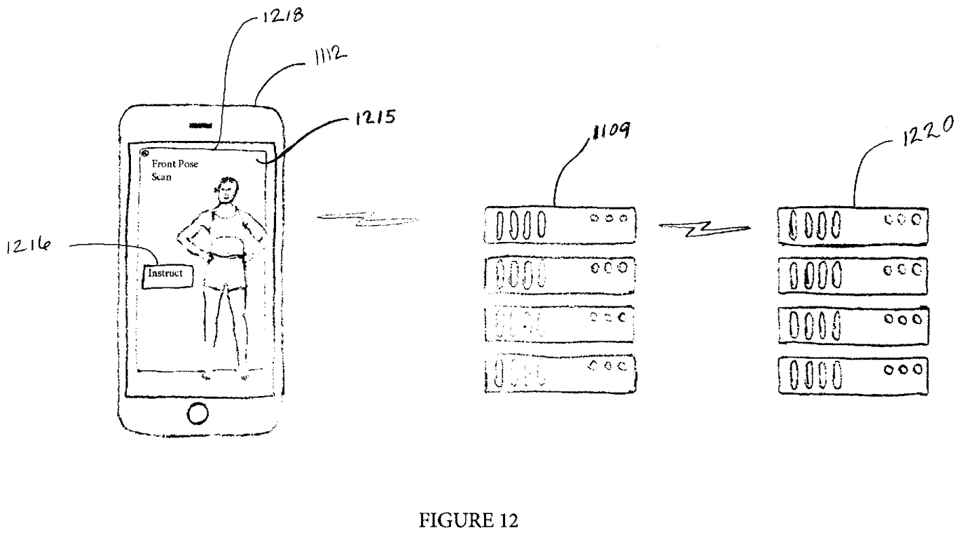

Referring now to primarily to FIGS. 11 and 12, and initially to FIG. 11, a representative environment for operation of a clothing size determination system 1100 according to one illustrative embodiment of the present disclosure is presented. A human subject 1102, for whom clothes dimensions are to be obtained, is positioned a way from a wall or other objects while a user 1110 captures a photograph with a mobile smart phone 1108 or other device that captures digital images. The mobile smart phone 1108, which is manipulated by the user 1110 (e.g., photographer), is configured to display a real-time video image provided by a camera 1112 configured in the mobile smart phone 1108.

The user 1110 who is going to take measurements of the human subject 1102 has an application (or “app”) on their mobile smart phone 1108. Some of the processing will take place on that mobile smart phone 1108 and a good portion of it will take place on one or more servers 1109. The servers 1109 may be communicatively coupled by wireless 1111 or by a wired connection. The application may include other features that allow for the ordering of clothes once the dimensions are determined or other features.

To begin use, the user 1110 starts the application on the mobile smart phone 1108 and then enters the user's height on a screen 1215. In this illustrative embodiment, a feature of known dimension in the captured image is the person's vertical height and not a separate reference target. For example, the person 1102 may enter 5 foot, 7 inches.

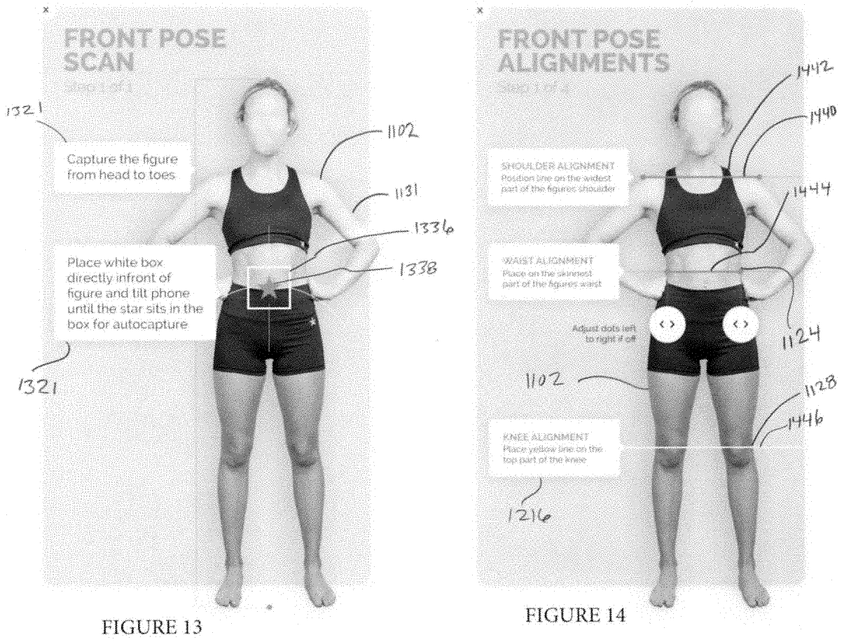

Referring now to FIG. 13, after the persons 1102 height is entered, the camera 1112 opens up and instructions 1321 may be included (see also example instructions 1216 in FIG. 12) about how to best capture the photograph. The application, or app, may instruct the user 1110 how far to be away (distance 1113) from the human subject 1102, or person to be measured. Because in this embodiment the person being measured 1102—his or her height—is the known dimension, the person does not have to be against a wall and preferably is not. Moreover, having the wall at least 1-3 feet or greater away from the person 1102 can actually be helpful for removing shadows or other complicating images. The user 1110 taking the photograph may be positioned at the distance 1113 that allows the human subject 1102 to be comfortably within the camera frame 1218 and typically the distance 1113 is in the 6 to 8 feet. Other distances may be used.

The application on the mobile smart phone 1108 also includes a portion of software that will tell the user if the phone is straight or tilted based on the accelerometer features of the mobile smart phone 1108. Once the camera 1112 is in the correct orientation (0 degrees), the photograph may automatically be taken or in some embodiments could then be manually taken. To establish the correct position, an aiming system may be used; for example, a box 1336 is positioned directly in front of the image of the person 1102 and then a star 1338 or other symbol is placed in the box 1336. The initial photograph may be a front elevation view (as shown in FIG. 13) of the human subject 1102 with the subject's arms 1131 down on her or his hips 1126 and with shoes off. Once the image is captured, it is sent along with the known height that was entered to the server(s) 1109 for further processing.

The server 1109 receives a packet with the photograph and height information. In some embodiments, a second server 1220 is included that is a graphical processing unit (GPU). An openCV Hog cascade classifier may be used on one or more servers 1109, 1220 for face detection to make sure the image actually has a person in it before further processing.

In some embodiments, one of the first things the server 1109 does is send the image to the still more powerful server 1220 to help isolate the outline of the person 1102 being measured. In some embodiments this may be done using a DeepLab v3 Model. The DeepLab Model, e.g., DeepLab-v3+ implemented in TensorFlow, is a semantic image segmentation module as is known by those skilled in the art. From the output image from Tensor flow Deeplab v3 model with the image of the person 1102 cropped out, a technique of Canny edge detection may be used to generate an image with only the person's outline around his or her body. This portion of the system may be used to return just a color outline image of the person 1102 in the photograph. An open source computer vision (openCV) library, may be used to tune the values returned. That can be used to adjust the threshold on the image and make other adjustments.

The server 1109 processes the image that is now in the form of the outline before sending the image back to the mobile smart phone 1108. The server 1109 uses empirical information to make predictions about where certain body parts or locations are located within the modified image, e.g., chest 1122, waist 1124, hips 1126, knees 1128, arms 1131, which may include the arm's start 1130, arm end 1132 (i.e., wrist), and elbow 1133, or other locations. That image with the predicted or estimated locations is then sent back to the mobile smart phone 1108 where the user 1110 can make manual adjustments to those locations using sliders. As example of this is shown in FIG. 14.

In FIG. 14, three sliders are shown. Sliders 1440 for the person's 1102 shoulder width 1442 is shown. Also, sliders 1444 for the person's 1102 waist 1124 is shown. Finally, a slider 1446 is shown for the height of the person's 1102 knees 1128.

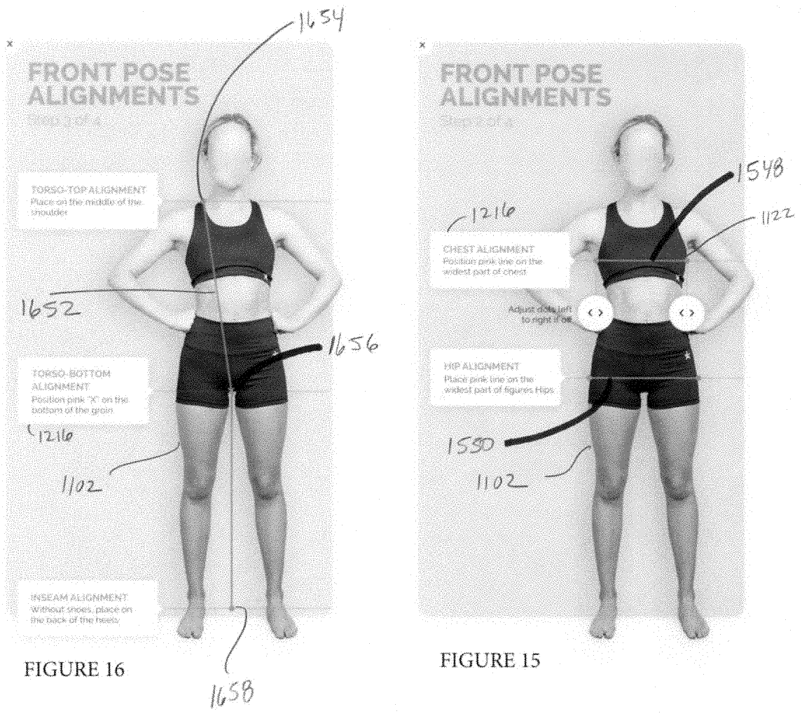

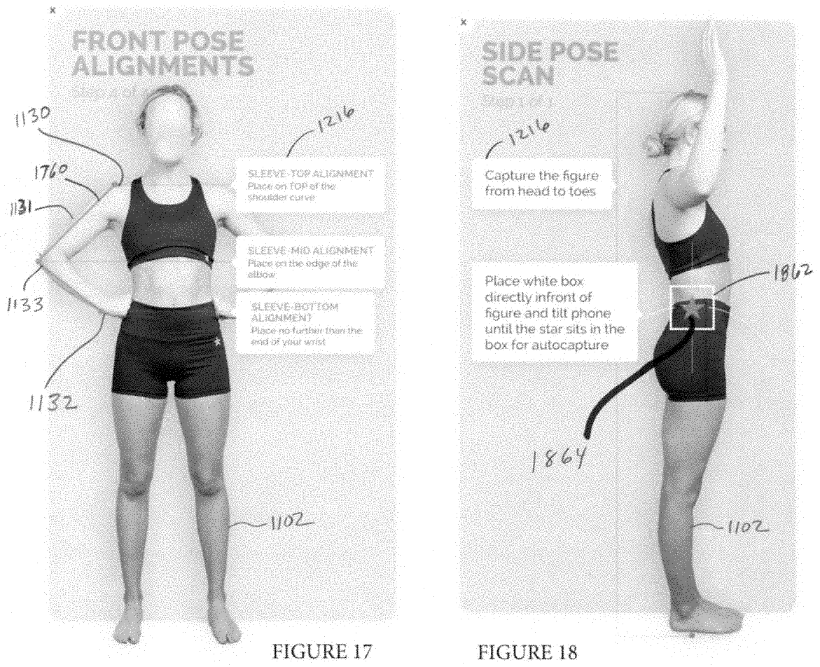

Similarly, FIG. 15 shows sliders 1548 for the person's 1102 chest 1122 and sliders 1550 for the person's 1102 hip 1126. In like fashion, FIG. 16, shows a slider 1652 going from a top torso 1654 location to a bottom torso 1656 location down to a bottom of the person's legs 1658 (e.g., back of heels). Likewise, in FIG. 17, shows an image of the person 1102 with a slider 1760 that goes from the top of the arm 1130 to the elbow 1133 and then to the wrist 1132. In this embodiment, adjustments can be made at the top of the slider, the elbow, and at the wrist. The top is placed at the shoulder curve. The elbow is placed at the edge of the elbow. The wrist is placed just above the wrist or on the wrist.

One of the other things happening in the server(s) 1109, 1220 is that the measurement ratio, or scaling ratio, is determined. This is done by determining the dimension of height in terms of pixels and then making the ratio with the known dimension of height that was entered by the user 1110. Because the person being measured 1102 sometimes wears her or his hair up or may have things that might distort the upper edge of the person, the protocol is to locate the persons eyes 1134 and use the estimated distance between the eyes and the feet 1136 based on the height they entered and using that in the ratio determination. In some embodiments, TensorFlow JS, or another like module, can be used to make the prediction of where the eyes 1134 are for determining the feet 1136 to eyes 1134 pixel distances. Then the known dimension of height is adjusted by decreasing the average percentage for where eyes are from the top of one's head. For example if it's known that the average eyes are at 98% of the height from the floor, the known height may be shortened to 0.98*known height. So the scaling ratio in that example would be: (0.98*known height)/toe-to-eyes pixel distance.

The initial predictions of locations of body parts or portions may be based on averages from previous uses, i.e., empirical data. For example, the empirical data may show that the person's chest 1122 is located at 80% of their height and their waist 1124 is located at 55% of their height. The image may have adjustments made by the user for the chest 1122, waist 1124, hips 1126, wrists 1132, other body part locations. In this way, an initial prediction may be presented to the user 1110 for correction or adjustment using sliders. When the user makes the adjustments with the slider, corrected values are sent to the server. The regression-derived weights for a regression-derived formula may also be sent from the server 1109 as described further below.

In some embodiments, the application on the server 1109, 1220 will place a slider at an initial predicted spot. To identify locations, in some embodiments, an OpenCV Hog cascade classifier may be used for the upper body and lower body separation before applying human body ratios to figure out waist/chest/knee positions.

Referring now to FIG. 18, the user 1110 may then be prompted to take the side elevation view photograph of the person 1102 to be measured, or human subject. The same process as referenced above for the front elevation photograph can be repeated for this second image. Thus, a box 1862 is positioned directly on the image of the person 1102 and the camera 1112 tilted until a star 1864 is in the box 1862. The photograph, or second image, is then taken automatically or manually. After the second image is sent to the servers 1109, 1220, the image is processed as the first one was. The second image with predicted locations is then sent to the mobile smart phone 1108, so that corrections or adjustments can again be made using sliders. One difference on the side elevation is that the prediction of location may be adjusted based on the corrections made with the slider on the first image, or front image, that was sent over. For example, if the slider correction showed movement 5% below the initial predicted location with respect to overall height, the predicted location on the next image might be sent over already positioned 5% lower.

As the predicted values are sent from the server 1109 to the mobile smart phone 1108, in some embodiments, they may also come with parameters for a formula for further calculations. Those parameters are determined through empirical analysis of known human subjects. The issue is that not everyone has the same body styles and it can be difficult to take a dimension determined with a two-dimensional front view measurement and with a two-dimensional side view dimension to figure out the three-dimensional girth of the person being measured. To address this, correlations may be done between the various measurements made by the system and waist dimensions or chest dimensions of the same people that were known. In one approach, 80 people were measured by the system and then their actual waist size (full girth) was measured. The first 50 were used to develop the database, which included sizing dimensions maintained in matrices, e.g., 1×9 matrix for each. The next 30 were used as test cases and found to be within acceptable tolerance, e.g., predicting waist dimensions within one inch. The formula was calculated using linear regression and so referenced, but is meant to include other statistical means for fitting a formula.

In one illustrative embodiment, a matrix A was done for the sample group that had nine data points (9×1 matrix for each person): chest front, chest side, waist front, waist side, hip front, hip side, hip front/hip side, waist front/waist side, chest front/chest side. A second matrix, B, included the data points for the physical tape measurement of the waist. Then A*X=B and solving for X comes to X=A−1*B. So X is found and the weights may be sent to the mobile smart phone 1108 for use in the formula. Again, linear regression may be used for this, but “regression based” is meant to include any statistical approach for fitting a data to a formula. This approach may be used for each body part—typically on an issue with girths—being used although different input measurements (matrix A) may be used for different body parts. These weights may be sent with the image going back to the mobile smart phone 1108.

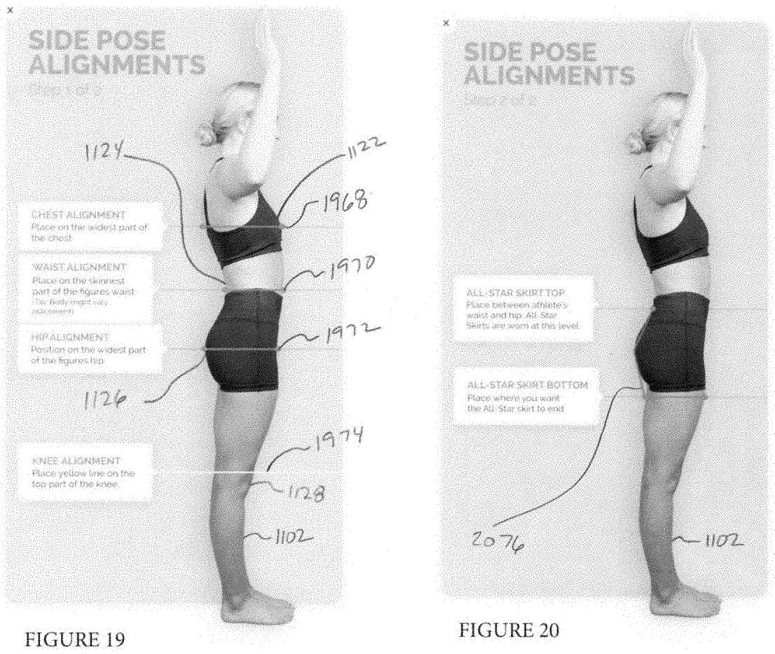

Referring to FIG. 19, the predicted locations with sliders may be sent from the server 1109 to the mobile smart phone 1108 as suggested in FIG. 19. There, sliders 1968, 1970, 1972, and 1974 are shown for the chest alignment, waist alignment, and hip alignment, and knee alignment. The slider 1968 may be placed on the widest part of the chest 1122 if not already there. The slider 1970 may be placed on the skinniest part of the person's waist 1124 if not already there. The slider 1972 may be positioned on the widest part of the person's hip 1126 if not already there. Finally, the knee-alignment slider 1974 may be placed on the top part of the knee 1128. The knee slider 1974 is slightly different in that it only is trying to identify a height.

In one embodiment, the formula with nine parameters may be used with different weights for measuring the hip 1126 and chest 1122 where the girth cannot be measured directly in the photographs, but other dimensions may be measured directly using the pixel or measurement ratio. For example, with reference to FIG. 20, a skirt-slider 2076 is positioned to measure for skirts. The skirt length may be determined from the slider 2076 along with hip front and hip side. The first end of the slider 2076 is positioned at the person's 1102 waist and hips and the other end of the slider is placed at the bottom below the hip where the user wants the bottom of the skirt to be located.

In determining sizing dimensions or nominal dimensions, the system can use the scaling ratio and pixel map. The pixel distance can be determined and then converted to actual dimensions or nominal dimensions. For other measurements—typically the ones involving a girth—the formula is used with multiple variables to determine the measurement. For measuring the sleeve, inseam, torso, and other non-girth measurements, one may use the slider measurements as is and convert the pixel length to physical measurements with the measurement ratio.

In some embodiments, the process may depend on where the user is asked to place the sliders. These placements are important for accuracy, as well as, the entire model is built using measurements obtained for these slider positions. That is one reason that on-screen instruction boxes 1216 may be included.

In some embodiments, the initial inquiry about height may be followed by a selector of body type with exaggerated images for the user to select. That may then be used to indicate to the server that a different empirical database should be used for the weighted constants for that group. For example, if the selected body type of an extreme athlete (fit hard body), then a database built with 30 or more such athletes might be consulted for the formula parameters.

Returning to the sliders, e.g., sliders 1440, 1444, 1446, 1548, 1550, 1652, 1760, 1968, 1970, 1974, that the user 1110 will adjust, the user 1110 can move, using the user interface, the slider to the correct location. After the server 1109, 1120 does the segmentation and sends just the outline of the person 1102, the image may be a white image with black dots where the person used to be. The image is resized, however, to the same size as the image that was sent and the original image can be put on top of it. Said another way, the outline may be placed underneath the original image that was sent so that the original image is right on top of the outline. In that way, the user does not see the outline that has been produced but it is there underneath the original image. The slider, which is then on top of that original image, is really tracking the outline behind the original image. The user 1110 will see the slider move on the front but the slider is really moving on the outline behind the original image. This may be done in many ways; one is to use P5 JS, which is a JavaScript library entry.

When the sliders are adjusted for the side elevation view (see, e.g., FIG. 19), the data being sent to the server 1109 at that point is actually the measurements. This is because the exact location has been determined and the weighting for the formula has already been sent to the mobile smart phone 1108. So everything needed for the calculations is on the phone 1108 at that point and so the sizing dimensions or nominal dimensions are what are then sent over to the server 1109 by the mobile smart phone 1108. At the server 1109, the dimensions can be stored with an identification for the person 1102 for later access. For example, the later access may be when the user is ordering a uniform or other clothing garment. The dimensions may also be accessed when the user is shopping in a retail environment in a physical store or online and needs those dimensions to be used to interface with brand sizes.

For the retail portion, a commercial portal for a website or app can be set up, and as an aspect of that, sizing charts included that are correlated with the various actual body dimensions. For example, the chart may say that a small size is the same as having a waist size that is in the range of X1-X2. This could also be done with multiple variables in some embodiments. When the person who wants to order uniform then arrives at the website, they enter their ID and the server provides the size uniform based on the lookup. In some embodiments, the website or app may graphically show where the person's actual dimensions fall on the sizing chart that shows the full range. Thus, if somebody is between a small and a medium, the person can manually decide which size they prefer.

As an illustrative example with retail online site, a user enters their identification and then the online retailer will use that identification to access the server and access the user's dimensions and the dimensions can then be used to get the brand size or sizes.

According to one illustrative embodiment, a computer-implemented method to determine clothing dimensions of a person to be measured, the method for use with a mobile smart phone, the method comprising: positioning the person to be measured against a wall with a reference target on the wall, wherein the reference target is of a known size or contains features of a known size; capturing at least one photograph of the person against the wall with the reference target with the mobile smart phone, wherein the photograph contains an image of the person and the reference target; developing a pixel map of the photograph using a processor of the mobile smart phone or of a server in communication with the mobile smart phone; identifying the reference target or features of the reference target and determining pixel dimensions of the reference target or features and developing a scaling ratio based on the pixel dimensions and known dimensions for the reference target or the features; identifying an outline of the image of the person in the photograph or a portion thereof; determining a pixel dimension of one or more portions of the person to be measured; and using the scaling ratio to convert the pixel dimension of one or more portions of the person to be measured to a sizing dimensions.

According to one illustrative embodiment, a clothing size determination system comprising: a clothing-sizing tool stored in a memory and executed by a processing system to: receive image data from a camera, the image data representing an image of a human subject and a two-dimensional reference target, the human subject and the two-dimensional reference target disposed proximate one another within the image data; process a two-dimensional reference target portion of the image data to measure a known distance on the reference target in terms of pixels or other measurement units; produce a measurement ratio comparing the known dimension on the two-dimensional reference target to the pixels or other measurement units of the known distance; process the photograph to identify one or more body features of the human subject; determine a measurement of the one or more body features in terms of pixels or other measurement units; and use the measurement ratio and the measurement of the one or more body features in terms of pixels or other measurement units to determine one or more nominal dimensions corresponding to each of the one or more body features of the human subject.

According to one illustrative embodiment, a customized clothing fitting system comprising: a clothing sizing service stored in a memory and executed by a processing system to: receive one or more manufacturer's size charts associated with one or more clothing items provided to a retailer from a manufacturer, each of the manufacturer's size charts including a plurality of specified clothing sizes for each of the provided clothing items and a plurality of corresponding nominal dimensions; store the plurality of specified clothing sizes and corresponding nominal dimensions in a database; receive a unique identifier of a consumer from a consumer computing device; obtain one or more nominal dimensions associated with body features of the consumer; search through the database to identify one or more of the clothing items having one or more nominal dimensions that match one or more of the nominal dimensions of the consumer; and transmit information associated with the identified one or more clothing items to the consumer computing device.

According to one aspect of the present disclosure, a clothing size determination system includes an executable clothing-sizing tool that receives data from a camera representing an image of a human subject and a two-dimensional reference target. The human subject and the two-dimensional reference target are positioned proximate one another within the image. The system processes a two-dimensional reference target portion of the image data to measure a relative distance of the camera from the human subject in which the relative distance is measured according to a size of the two-dimensional reference target portion relative to the overall size of the image. Using the measured relative distance, the system displays a visual indicator for indicating to a user of the camera, a desired distance of the camera from the human subject or an optimum orientation of the camera relative to the human subject. The system also receives and processes a photograph of the image to determine one or more body features of the human subject. Using the determined one or more body features, the system processes the photograph to determine one or more clothes dimensions corresponding to one or more body features of the human subject by comparing a relative size of each of the body features against the size of the two-dimensional reference target. Additionally, the system may adjust the determined clothes dimensions according to an empirical training model in which the determined one or more clothes dimensions are compared against the one or more body dimensions of a plurality of other human test subjects having known clothes dimensions.

The system herein may also be used to estimate Body Mass Index (BMI) and Body Fat Percentage by measuring chest, waist, upper arms, thighs and hips. With the user input of height, weight, gender or demographic information, the system can compute body fat percentage comparing the measurements to a database of already existing user information. This approach is similar to how the girth dimensions were determined.

Body fat percentage is measured in several different ways: by fully immersing the body in water and measuring the displaced water and change in weight, body scanning, calipers measurement etc. While these measurements use different ways to compute the body fat, the results also vary. From various body measurements taken from the current system, body fat percentages can be computed by taking some or all of these measurements, gender, weight and/or height.

With respect to the above description, it is to be realized that although embodiments of specific material, representations, iterations, applications, configurations, networks, and languages are disclosed, those enabling embodiments are illustrative and the optimum relationship for the parts of the invention may include variations in composition, form, protocols, function, and manner of operation, which are deemed readily apparent to one skilled in the art in view of the present disclosure. All relevant relationships to those illustrated in the drawings and the specification are intended to be encompassed by the claims of the present disclosure. Therefore, the foregoing is considered as merely illustrative of the principles of the present disclosure. Numerous modifications will readily occur to those skilled in the art. It is not desired to limit the present disclosure or the claims to the exact construction and operation shown or described, and all suitable modifications and equivalents may be resorted to, falling within the scope of the present disclosure.

Although the present invention and its advantages have been disclosed in the context of certain illustrative, non-limiting embodiments, it should be understood that various changes, substitutions, permutations, and alterations can be made without departing from the scope of the invention as defined by the claims. It will be appreciated that any feature that is described in a connection to any one embodiment may also be applicable to any other embodiment.

What is claimed is:

1. A computer-implemented method to determine clothing dimensions of a person to be measured, the method for use with a mobile smart phone and at least one server, the method comprising:
receiving an input of a known dimension of a feature of the person to be measured, wherein the input is made on the mobile smart phone;
capturing at least one photograph of the person with the mobile smart phone, wherein the photograph includes the feature with the known dimension;
developing a pixel map of the photograph using a processor of the mobile smart phone or of the at least one server in communication with the mobile smart phone;
identifying the feature having the known dimension and determining pixel dimensions of the feature using the pixel map, and developing a scaling ratio based on the pixel dimensions and the known dimension for the feature;
identifying an outline of the image of the person to be measured in the photograph or a portion thereof;
determining a pixel dimension of one or more portions of the person to be measured; and
using the scaling ratio to convert the pixel dimension of the one or more portions of the person to be measured to a sizing dimensions.

2. The computer-implemented method of claim 1, wherein the known feature of the person to be measured is a vertical height of the person to be measured.

3. The computer-implemented method of claim 1, wherein using the scaling ratio to convert the pixel dimension of the one or more portions of the person to be measured to the sizing dimensions is done for the person's arm length or inseam.

4. The computer-implemented method of claim 1, further comprising:
sending the outline of the image to a user with sliders to identify an exact location of the person's chest front, chest side, waste front, waist side, hip front, hip side;
calculating hip front/hip side, waist front/waist side, chest front/chest side;
putting the chest front, chest side, waist front, waist side, hip front, hip side, hip front/hip side, waist front/waist side, chest front/chest side inputs into a regression-derived formula wherein equation weights are found by regression of a sample pool of at least 30 people;
using the regression-derived formula to determine an estimate (within 5% accuracy) of the person's girth at the person's waist and chest.

5. The computer-implemented method of claim 4, wherein the sizing dimensions determined using the scaling ratio from direct pixel map to actual dimension includes arm length and inseam, and the sizing dimensions determined by the regression-derived formula includes the person's chest girth and waist girth, such that the sizing dimensions all together include arm length, inseam, waist girth, and chest girth; and further comprising determining a garment size by looking for a closest match between the sizing dimensions and dimensions in a database that correlates with clothing sizes of a product offering.

6. The computer-implemented method of claim 4, wherein at least some of the sizing dimensions are determined by using the scaling ratio with the pixel map of portions of the outline of the image of the person and at least some of the sizing dimensions are by using the regression-derived formula.

7. The computer-implemented method of claim 4, wherein at least some of the sizing dimensions are determined by using the scaling ratio with the pixel map of portions of the outline of the image of the person and at least some of the sizing dimensions are by using the regression-derived formula; and further comprising determining a garment size by looking for a closest match between the sizing dimensions and dimensions in a database that correlate with clothing sizes of a product offering.

8. The computer-implemented method of claim 1, wherein capturing at least one photograph of the person comprises capturing a front elevation photograph and a side elevation photograph of the person to be measured.

9. A computer-implemented method to determine clothing dimensions of a person to be measured, the method for use with a mobile smart phone and at least one server, the method comprising:
receiving an input of a known dimension of a feature on the person to be measured or on a reference target within 12 inches of the person to be measured, wherein the input is made on the mobile smart phone;
capturing at least one photograph of the person with the mobile smart phone, wherein the photograph includes the feature with the known dimension;
developing a pixel map of the photograph using a processor of the mobile smart phone or of the at least one server in communication with the mobile smart phone;
identifying the feature having the known dimension and determining pixel dimensions of the feature using the pixel map, and developing a scaling ratio based on the pixel dimensions and the known dimension for the feature;
identifying an outline of the image of the person to be measured in the photograph or a portion thereof;
determining a pixel dimension of one or more portions of the person to be measured; and
using the scaling ratio to convert the pixel dimension of the one or more portions of the person to be measured to a sizing dimension.

10. The computer-implemented method of claim 9, wherein capturing at least one photograph of the person comprises capturing a front elevation photograph and a side elevation photograph of the person to be measured and further comprising:
sending the outline of the image to a user with sliders to identify an exact location of the person's chest front, chest side, waist front, waist side, hip front, hip side;
calculating hip front/hip side, waist front/waist side, chest front/chest side;
putting the chest front, chest side, waist front, waist side, hip front, hip side, hip front/hip side, waist front/waist side, chest front/chest side inputs into a regression-derived formula wherein equation weights are found by regression of a sample pool of at least 30 people; and
using the regression-derived formula to determine an estimate (within 5% accuracy) of the person's girth at the person's waist and chest.

11. The computer-implemented method of claim 9, wherein capturing at least one photograph of the person comprises capturing a front elevation photograph and a side elevation photograph of the person to be measured and further comprising:
sending the outline of the image to a user with sliders to identify slider-adjusted locations, which are exact locations of at least some anatomical parts of the person to be measured;
using pixel distances determined between the slider-adjusted locations with the scaling ratio to determine one or more sizing dimensions; and
using a regression-derived formula, wherein equation weights are found by regression of a sample pool, to calculate at least one or more sizing dimensions based on pixel dimensions at least at the person's waist.

12. A clothing size determination system comprising:
a clothing-sizing tool stored in a memory and executed by a processing system to:
receive image data from a camera, the image data representing an image of a human subject and a feature of known dimension, the human subject and the feature of known dimension in a same field of view or proximate one another;
process the feature of known dimension of the image data to develop a pixel-based measurement of the feature of known dimension;
produce a measurement ratio comparing the known dimension to the pixel-based measurement of the known feature;
process the photograph to identify one or more body features of the human subject for which sizing dimensions are desired;
determine a measurement of the one or more body features in terms of pixels; and
use the measurement ratio and the measurement of the one or more body features in terms of pixels to determine one or more nominal dimensions corresponding to the one or more body features of the human subject.

13. The clothing size determination system of claim 12, wherein the clothing size tool determines the one or more nominal dimensions corresponding to each of the one or more body features of the human subject by multiplying the measure of the one or more body features in terms of pixels by the measurement ratio to determine the nominal dimensions.

14. The clothing size determination system of claim 12, wherein the clothing-sizing tool stored in a memory and executed by a processing system to determine a waist girth, and wherein the one or more body features comprises the waist girth, and the processing system is configured to determine a front waist pixel dimension and a side pixel dimension, and then using a weighted regression formula based on samples of at least 30 people, determine the waist girth within five percent.

15. The clothing size determination system of claim 12, wherein the clothing-sizing tool stored in a memory and executed by a processing system is further configured to:
receive camera orientation data from a rotation sensor component that is physically coupled to a camera,
provide an indication of an adjustment needed to the user to orient the camera to be at parallel with a gravity field.

16. The clothing size determination system of claim 12, wherein the photograph comprises each of a front photograph and a side photograph, the front photograph representing a front image of the human subject, and the side photograph representing a side image of the human subject.

17. The clothing size determination system of claim 12, wherein the body features comprise at least one of a waist size, a chest size, a torso length, a leg length, and a shoulder width.

18. A customized clothing fitting system comprising:
a clothing sizing service stored in a memory and executed by a processing system to:
receive one or more manufacturer's size charts associated with one or more clothing items provided to a retailer from a manufacturer, each of the manufacturer's size charts including a plurality of specified clothing sizes for each of the provided clothing items and a plurality of corresponding nominal dimensions;
store the plurality of specified clothing sizes and corresponding nominal dimensions in a database;
receive a unique identifier of a consumer from a consumer computing device;
obtain one or more nominal dimensions associated with body features of the consumer;
search through the database to identify one or more of the clothing items having one or more nominal dimensions that match one or more of the nominal dimensions of the consumer;
transmit information associated with the identified one or more clothing items to the consumer computing device;
wherein the one or more nominal dimensions is determined using a clothing size determination system; and
wherein the clothing size determination system comprises:
a clothing-sizing tool stored in a memory and executed by a processing system to:
receive image data from a camera, the image data representing an image of a human subject and a feature of known dimension, the human subject and the feature of known dimension in a same field of view or proximate one another,
process the feature of known dimension of the image data to develop a pixel-based measurement of the feature of known dimension,
produce a measurement ratio comparing the known dimension to the pixel-based measurement of the known feature,
process the photograph to identify one or more body features of the human subject for which sizing dimensions are desired,
determine a measurement of the one or more body features in terms of pixels, and
use the measurement ratio and the measurement of the one or more body features in terms of pixels to determine one or more nominal dimensions corresponding to the one or more body features of the human subject.

19. The customized clothing fitting system of claim 18, wherein the clothing selection service is further configured to:
receive a request for a particular type from among a plurality of different types of clothing items from the consumer computing device;
filter the plurality of different types of clothing items according to one or more criteria specified in the request;
filter the plurality of different types of clothing items to identify those matching one or more nominal dimensions of the consumer; and
transmit the information associated with the identified one or more filtered clothing items to the consumer computing device.

20. The customized clothing fitting system of claim 18, wherein the clothing selection service is further configured to:
receive a request for a particular fit style from among a plurality of different types of clothing items from the consumer computing device, the fit style comprising at least one of a loose fit, a regular fit, and a tight fit;
apply a weighting factor to the one or more nominal dimensions associated with the consumer; and
search through the database to identify one or more of the clothing items having the one or more clothing sizes that match the one or more weighted measured body dimensions of the consumer.
